(19) United States
(12) Patent Application Publication
(10) Pub. No.: US 2015/0260392 A1
(43) Pub. Date: Sep. 17, 2015

(54) LIGHTBULB LOUDSPEAKER

(71) Applicant: DR. G LICENSING, LLC, Reno, NV (US)

(72) Inventor: Godehard A. Guenther, Reno, NV (US)

(73) Assignee: DR. G LICENSING, LLC, Reno, NV (US)

(21) Appl. No.: 14/519,865

(22) Filed: Oct. 21, 2014

Related U.S. Application Data
(60) Provisional application No. 61/922,347, filed on Dec. 31, 2013.
(60) Provisional application No. 61/905,963, filed on Nov. 19, 2013.
(60) Provisional application No. 61/901,792, filed on Nov. 8, 2013.
(60) Provisional application No. 61/893,722, filed on Oct. 21, 2013.

(51) Int. Cl. F21V 33/00; H04R 1/02

(52) U.S. Cl. CPC F21V 33/0056; H04R 1/028

(57) ABSTRACT

The foregoing are among the objects attained by the invention, which provides in some aspects a loudspeaker adapted for mounting in a lightbulb socket. The loudspeaker has a body that can, for example, be shaped like a lightbulb and that has a concavity that includes a first volumetric region. A wall that is disposed within the body and that at least partially defines that region includes one or more active diaphragms. The diaphragms generate (i) front waves directed from the first volumetric region to at least one of an environment and a second volumetric region, if any, defined within the concavity, and (ii) back waves directed into the volumetric region. A passive radiator that is elastically mounted in the wall passes from the volumetric region at least a portion of back waves generated by one or more of the active diaphragms.

This claims the benefit of filing of U.S. Patent Application No. 61/905,963, filed Nov. 19, 2013, U.S. Patent Application No. 61/901,792, filed Nov. 8, 2013, U.S. Patent Application Ser. No. 61/893,722, filed Oct. 21, 2013, and U.S. Patent Application Ser. No. 61/822,479, filed May 13, 2013. The teachings of the aforementioned applications are incorporated by reference herein.

### BACKGROUND OF THE INVENTION

The invention relates to sound reproduction and, in particular, for example, to improved audio devices for residential and commercial structures. The invention has application, for example, in adapting incandescent and other lighting sockets to provide sound as well as illumination.

A large percentage of loudspeakers used in audio systems are electrodynamic speakers. They typically comprise drivers that are mounted within enclosures, which may be dedicated housings (such as speaker cabinets) or casings of other devices (such as PDAs) of which the speakers are a part. A driver is usually made of up a magnetic motor that moves a diaphragm to radiate sound. Traditionally, diaphragms are cone-shaped and are disposed within a frame or basket, with the wide and narrow ends of the cone coupled to the frame by way of respective flexible membranes, referred to as the suspension or surround (in the case of the wide end) and the spider (in the case of the narrow end). Those membranes keep the diaphragm axially centered while, at the same time, permitting it move back and forth at audio frequencies.

The motor is made up of a voice coil, which is usually disposed behind the narrow end of the cone, and a magnetic circuit, which is usually disposed adjacent to and/or partially surrounding the coil. In operation, electrical audio signals from an amplifier (or other source) are applied to the voice coil, producing a varying electromagnetic field. This interacts with the magnetic field of the magnet circuit, causing the voice coil to move.

Because the voice coil is coupled to the diaphragm, its movement causes the diaphragm to pump in and out—explaining why the diaphragm and coil are sometimes referred to as a “piston.” That, in turn, causes air around the diaphragm to pressurize and depressurize, producing sound waves. The enclosure prevents sound waves emitted from the rear of the diaphragm from canceling those emitted from the front. Fabric batting may be provided within the enclosure to neutralize the internally reflected sound waves and to minimize resonances. A port or passive radiator (a/k/a passive diaphragm, e.g., one mounted in a frame, but not coupled to a motor) in the front of the cabinet radiates any of the internally reflected waves not absorbed by the batting, i.e., the lower frequency waves (which are physiologically less distinguishable and, hence, when reemitted add to the overall fidelity).

Traditionally, speakers are divided into three categories: woofer, midrange and tweeter. The woofer reproduces low frequency (bass) sound ranging from about 20 to 3000 Hz. The midrange speaker reproduces a broad spectrum of sound, typically from about 1000 Hz to 10 kHz. The tweeter speaker reproduces high frequency (treble) sound ranging from about 4 to 20 k Hz. In home audio systems, the woofer, midrange and tweeter are often housed in a single enclosure, as in the case of free-standing or floor speaker configurations. Where space is a consideration, the woofer and midrange may be combined in a single speaker, as in the case with bookshelf-sized speaker configurations.

Indeed, the functions of the woofer, midrange and tweeter may all be combined into one in the case of portable or embedded loudspeakers, e.g., of the type manufactured into smart phones, PDAs, MP3 players, sound cradles, and other handheld, portable and/or electronic apparatus. Unfortunately, it is typically difficult for speakers of this type to reproduce suitably low frequencies at reasonable volumes. In fact, because sounds in the mid-range frequencies are so much more efficiently generated, they tend to dominate small or low-powered speakers, making them sound “tinny.”

Prior to the innovations of the inventor hereof, the art has largely lacked small loudspeakers capable of high fidelity sound reproduction. Innovations by the inventor hereof have made possible improvement in this regard. For example, according to U.S. Pat. No. 7,532,737, a low-profile, two-way loudspeaker includes a cone-shaped diaphragm and a dome-shaped (tweeter) diaphragm. A front-mounted magnetic driver comprises first and second rare earth magnets each centrally disposed within electromagnetic shielding material. The driver and cone-shaped diaphragm are mounted to a speaker frame. The tweeter diaphragm is mounted onto the driver coaxially and substantially coplanar with a forward edge of the cone-shaped diaphragm.

By way of further example, U.S. Pat. No. 8,189,840, provides loudspeakers and electronic devices with improved radiators (or “passive drivers”) comprising an elastomerically mounted mass in order to improve sound reproduction fidelity. The mass comprises a component of the device not normally used for such purpose—e.g., a battery—thereby, permitting size reductions while, at the same time, enhancing audio fidelity.

Moreover, U.S. Pat. No. 7,302,076 discloses a low-profile speaker system that has a front diaphragm that is flat-, dome- or dish-shaped situated concentrically in a shallow region or plane with a back, cone-shaped diaphragm. The two diaphragms share a common magnet structure, with the front magnet being driven by a front gap of that structure, and the back magnet diaphragm being driven by a back gap.

The foregoing notwithstanding, there is increased demand for loudspeakers and/or electronic apparatus that incorporate them with improved fidelity and smaller size. Such are among the objects of the invention.

A related object is to provide such improved loudspeakers as adapted for installation in residential and commercial structures.

A further related object is to provide such improved loudspeakers as are adapted for use with lighting and lighting systems.

### SUMMARY OF THE INVENTION

The foregoing are among the objects attained by the invention, which provides in some aspects a loudspeaker adapted for mounting in a lightbulb socket. The loudspeaker has a body that can, for example, be shaped like a lightbulb and that has an inner concavity that includes a first volumetric region. A wall that is disposed within the body and that at least partially defines that region includes one or more active diaphragms.

Those diaphragms generate (i) front waves directed from the first volumetric region to at least one of an environment of the loudspeaker and a second volumetric region, if any, defined within the concavity, and (ii) back waves directed into the volumetric region. A passive radiator that is elastically mounted in the wall passes from the volumetric region at least a portion of the back waves generated by one or more of the active diaphragms.

Further aspects of the invention provide a loudspeaker, e.g., as described above, in which the active diaphragms are coupled to and driven by one or more active drivers which, themselves, are disposed in the volumetric region.

Yet still other aspects of the invention provide a loudspeaker, e.g., as described above, in which the passive radiator is annularly shaped. In related aspects of the invention, such an annularly-shaped passive radiator is disposed about one or more of the active diaphragms.

Further aspects of the invention provide a loudspeaker, e.g., as described above, in which the passive radiator is comprised of at least one of an elastomer and a sheet metal, such as brass.

Yet other aspects of the invention provide a loudspeaker, e.g., as described above, in which the one or more active diaphragms include a first active diaphragm and a second active diaphragm that is mounted coaxially onto a driver of the first active diaphragm. In a related aspect of the invention, the first active diaphragm is cone-shaped and the second active diaphragm is mounted substantially coplanar with a forward edge of the first active diaphragm. Still other related aspects of the invention provide a loudspeaker, e.g., as described above, in which the one or more active diaphragms and one or more active drivers form part of a two-diaphragm, concentric single-magnet speaker.

Still yet further aspects of the invention provide a loudspeaker, e.g., as described above, in which the one or more active diaphragms comprise first and second diaphragms coupled back-to-back with one another, the second diaphragm being cone-shaped and facing into the interior of the first volumetric region. In related aspects of the invention, the one or more active drivers comprise a voice coil at least partially disposed within a face of the cone-shaped second diaphragm.

### BRIEF DESCRIPTION OF THE DRAWINGS

A more complete understanding of the invention may be attained by reference to the drawings, in which:

FIG. 1 is a plan view of a loudspeaker suitable for mounting in a lightbulb socket according to one aspect of the invention;

FIG. 2 is a cross-sectional view of a loudspeaker of the type shown in FIG. 1;

FIG. 3 is a cross-sectional view of an alternate embodiment of a loudspeaker of the type shown in FIG. 2;

FIG. 4A is a exploded view of a loudspeaker of the type shown in FIG. 3;

FIG. 4B is a plan view of a passive diaphragm of a loudspeaker of the type shown in FIG. 4A;

FIG. 4C depicts the passive radiator of a loudspeaker of the type shown in FIG. 4A; and

FIG. 5 is a plan view of the loudspeaker shown in FIG. 4A.

### DETAILED DESCRIPTION OF THE ILLUSTRATED EMBODIMENT

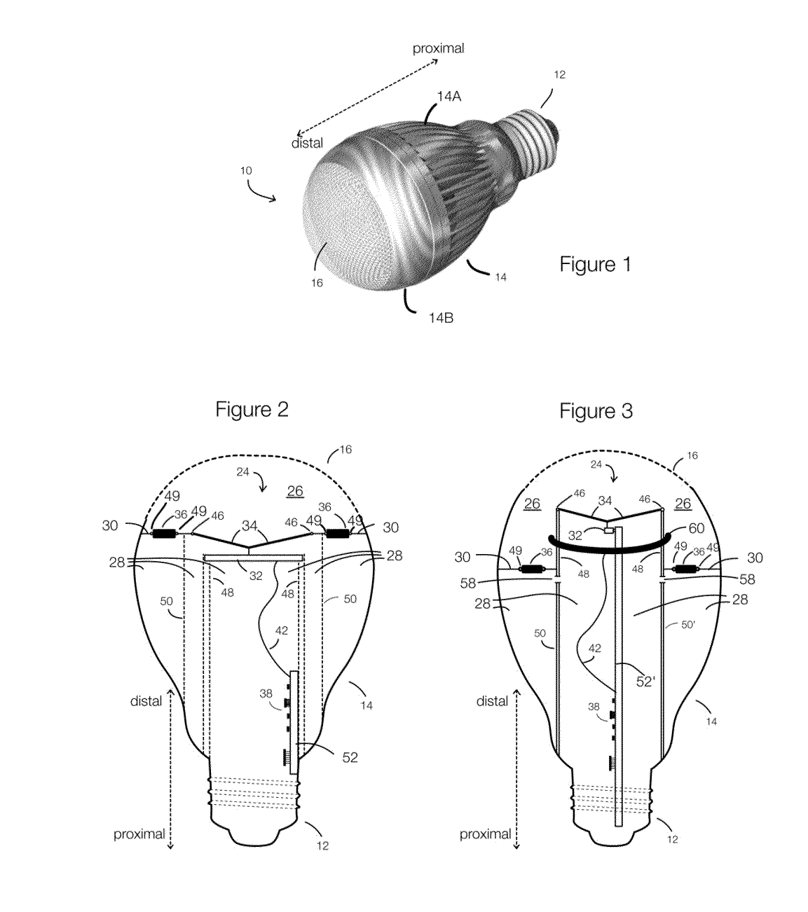

FIG. 1 depicts a loudspeaker 10 suitable for mounting in a lightbulb socket according to one aspect of the invention. The illustrated loudspeaker 10 includes a mounting adapter 12, a body 14, and a grill 16 generally arranged as shown.

The mounting adapter 12 of the illustrated loudspeaker 10 is a male screw-type mounting adapter of the type adapted for electromechanical coupling to a conventional E27 light bulb socket. In other embodiments, alternative mounting adapters 12 can be used for mechanical and/or electromechanical coupling to other styles of sockets, whether of the type conventionally used for lightbulbs or other lighting sources, other electrical devices, or otherwise. By way of nonlimiting example is a mounting adapter 12 of the type adapted for mechanical and/or electromechanical coupling to an automobile cigarette lighter socket, to a residential/commercial smoke detector mount, or otherwise.

The body 14 of illustrated loudspeaker 10 is generally bulb-shaped and is sized to fit a conventional lighting fixture, e.g., a ceiling mounted can-style fixture, a ceiling- or wall-mounted flood or spotlight fixture, a desk or floor lamp fixture, and so forth, just to name a few. In other embodiments, the body 14 is shaped and sized otherwise, e.g., for use in a “bare” fixture. Body 14 can be fabricated from glass, ceramic, wood, metal, epoxies, polymers, other materials (and/or a combination of the foregoing) selected, for example, based on intended uses of the loudspeaker 10.

In the illustrated embodiment, the body 15 is a multipart fabrication, though, other embodiments may vary in this regard. The illustrated multipart fabrication includes, for example, a base portion 14A that is extends from and is mechanically coupled to mounting adapter 12, and a top portion 14B that is extends from and is mechanically coupled to base portion 14A, as shown. Such mechanical coupling can be provided, by way of example, by adhesives, welding, friction fit, threading or otherwise.

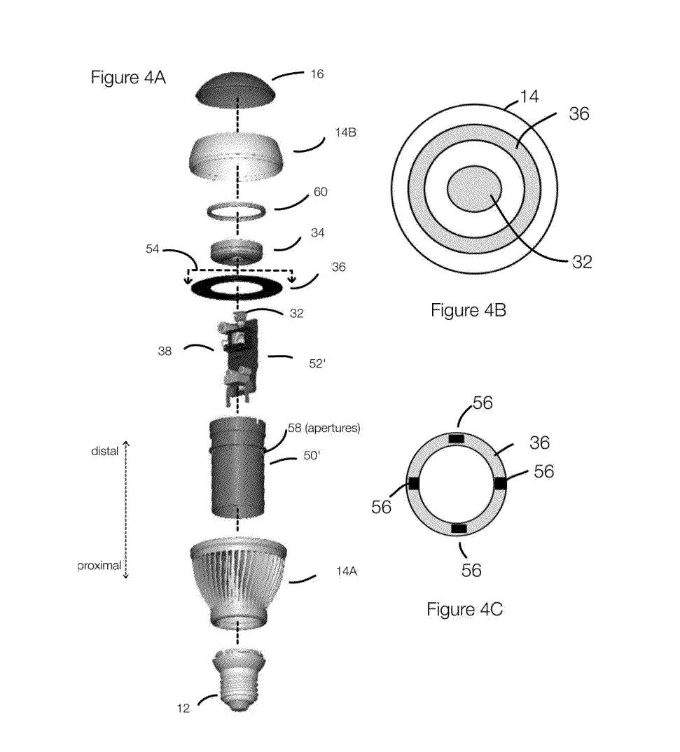

Referring to FIG. 4A, the base portion 14A of the illustrated embodiment serves as a heat sync, drawing away and dispersing to the environment surrounding loudspeaker 10 excess heat from the interior of the body 14, whence the aforesaid sound-making componentry, light sources and/or other optional apparatus are disposed. To that end, the base 14A can be of a finned metal or other construction suitable for such purpose.

The top portion 14B of base 14 can serve a number of functions, depending on the intended use of loudspeaker 10. For example, in addition to providing visual and/or physical shielding for components of the loudspeaker, it can define a cavity for focus and/or resonance of sound waves emitted by the active and passive diaphragms 34, 36. To these ends, the top portion 14B of the illustrated embodiment is generally sized and shaped as shown in the drawings, and it can be fabricated from glass, ceramic, wood, metal, epoxies, polymers, other materials (and/or a combination of the foregoing) selected, for example, based on intended uses of the loudspeaker 10, as well as on the desired function of element 14B.

The grill 16, which is not utilized in some embodiments, is a wire mesh, fabric, foam or other covering suitable for visually, mechanically, electrically, environmentally and/or otherwise shielding the content of loudspeaker 10 and/or for enhancing its appearance. The illustrated grill 16 minimally attenuates sound emitted by the loudspeaker 16, though, in other embodiments the grill 16 provide bandwidth-based or other attenuation, augmentation or otherwise.

Loudspeaker 10 includes componentry for making sound, as discussed below. And, as will also be apparent, in the illustrated embodiment, it also includes LED or other lighting sources, though, other embodiments may differ in this latter regard, e.g., foregoing such lighting sources and/or including other electrical, electromechanical or other functionality instead or in addition—e.g., smoke detection apparatus, add-on electrical sockets for plugging-in of extension cords or other apparatus, and so forth.

FIG. 2 is a cross-sectional view of a loudspeaker of the type shown in FIG. 1. As shown in FIG. 2, the interior of body 14 defines a concavity 24 that includes a proximal volumetric region 28 defining a space in which active driver 32 can reside and in which back waves generated by the active diaphragm 34 are captured and reflected (by the interior of body 14 and componentry therein) for transmission to the listener via passive radiator 36 (and grill 16). In these regards the region 28 serves, at least in part, in the manner of the enclosure portion of a more traditional loudspeaker. Its size and shape, which are defined, in part, by the position of the wall 30 within the concavity 24, as well as by the portion of the concavity proximal to the mounting adapter 12, can be adapted (to the extent afforded by other design constraints) to the device 10 as a loudspeaker.

The wall 30 is disposed at the distal end of the volumetric region 28 and seals that region from (i) a distal region 26 defined within the concavity 24 and/or the grill 16, as shown, and/or (ii) the environment surrounding the loudspeaker 10. In the illustrated embodiment, the seal is hermetic in order to minimize transmission of back waves generated by the active diaphragm 34 other than via passive radiator 36. In other embodiments, the seal is lossy and, thereby, permits transmission of at least some of those waves, directly, through the passage of air from the volume 28 to the region 26 and/or environment. The wall 30, which may be mounted in frame members 50 integral, affixed within the body 14 at the inside of the concavity 24 or otherwise, can be fabricated from the materials discussed above in connection with the body 14 or otherwise.

Disposed in wall 30 are one or more active diaphragms 34, each coupled to and reciprocated (or otherwise driven) by respective active drivers 32. Seals 46 can help secure the diaphragms 34 within the wall 30, as well as provide hermetic sealing therefor.

Though a single diaphragm 34 and driver 32 can be utilized, the illustrated embodiment employs a concentric pair of such diaphragms 34 and drivers 32 in body 14. Regardless of their number and configuration, the diaphragms 34 and drivers 32 can be of the type known in the art for use with headphones and/or personal audio systems. Preferred diaphragms and drivers are of the type disclosed and/or claimed in the many patents and patent applications assigned to the assignee hereof and, still more preferably, for example, in those disclosed and/or claimed in aforementioned U.S. Pat. Nos. 7,532,737 and 7,302,076, the teachings of which are incorporated herein by reference. In other embodiments of the invention the driver 32 and diaphragms 34 are configured and operated in the manner of the three-part piston described in U.S. Pat. No. 8,526,660, i.e., a three-part piston having first and second active diaphragms coupled back-to-back, with one of the diaphragms facing outwardly (i.e., toward the exterior of the loudspeaker 10) and the other diaphragm facing inward (i.e., into the interior of the volumetric region 28), and having an active driver 32 with a voice coil that is face-mounted within the inward-facing diaphragm.

The driver(s) 32 may, themselves, be disposed in proximal volumetric region 28, e.g., immediately “behind” the respective diaphragm(s) 34 or otherwise. They may be mounted in a frame 48 integral and/or affixed to the body 14 at the inside of the concavity 24, and they may receive power via wiring 42, as shown. In some embodiments, the driver(s) are mounted on a printed circuit board 52 on which circuitry 38 and/or other electronic componentry of loudspeaker 10 is/are disposed.

The driver(s) 32 reciprocate (or otherwise drive) the respective active diaphragm(s) 34 which, in turn, cause air around them to pressurize and depressurize, effecting (i) frontward-directed (or outward-directed) sound waves, i.e., “front waves,” moving in the direction from the wall 30, through the distal volumetric region 26 (if present), and outward of the concavity 24, and (ii) rearward-directed waves (or inward-directed), i.e., back waves, that radiate into proximal volumetric region 28.

The back waves are reflected by internal surfaces of the proximal volumetric region 28, e.g., inner walls of concavity 24, frames 48, 50, y within the region 28, and so forth. Fabric batting, not shown, can be provided in proximal volumetric region 28 to attenuate higher frequencies within those back waves, minimize internal reflections and reduce resonances. A foam member of the type disclosed for use in loudspeakers and other handheld, portable and/or electronic apparatus in copending, commonly assigned U.S. patent application Ser. No. 13/557,410, filed Jul. 25, 2012, and corresponding International Publication number WO 2013016375, both entitled “Ultra-Low Profile Loudspeakers,” and, more specifically, by way of nonlimiting example, as element 34 in FIGS. 2A and 2B thereof, and the accompanying text, the teachings of which application, figures and text are incorporated herein by reference, can be used instead of or in addition to such fabric batting.

Passive radiator 36, which is disposed in wall 30, radiates frontward, as further front waves, those back waves internally reflected within the proximal volumetric region 28 not absorbed by the fabric batting, foam or otherwise. Seals 49 can help secure the passive radiator 36 within the wall 30, as well as provide hermetic sealing therefor. Alternatively or in addition, the passive radiator 36 can be overmolded or otherwise secured to the wall 30.

The passive radiator 36 of the illustrated embodiment is annularly shaped as shown in FIG. 4C and is disposed about the active diaphragms 32, e.g., as shown in FIG. 4B. In other embodiments, the passive radiator 36 may be shaped otherwise and multiple passive radiators 36 may be provided in wall 30 of the same or varying shapes.

The passive radiator 36 can comprise a rubber or other elastomeric sheet, sized and sealed, e.g., to the wall 30. Alternatively, or in addition, it can comprise such an elastomeric member that is overmolded onto the wall 30. Passive radiator 36 is not limited to elastomeric compounds, and other materials suitable for radiating frontward, as further front waves, back waves internally reflected within the proximal volumetric region 28 can be used instead or in addition. By way of nonlimiting example, in some preferred embodiments, the radiator 36 is fabricated, in whole or part, from a sheet of brass or other metal, which can be coated, e.g., with an elastomer or otherwise on one or both (e.g., proximal and/or distal) sides.

The passive radiator 36 can further comprise, in addition to such a elastomeric and/or other materials, one or more masses of the type used with the passive radiator disclosed in commonly-assigned U.S. Pat. No. 8,189,840, entitled “Improved Loudspeaker and Electronic Devices Incorporating Same,” and, more specifically, e.g., in FIG. 2B of that patent and in the accompanying text, the teachings of which patent, figure and text are incorporated herein by reference. As evident there, such a mass can be a battery 40 or other component of the device not normally used for such purpose.

However, as in the illustrated embodiment of the present application, that mass may instead or in addition comprise inert pieces of rubber, ceramic, metal, plastic, wood or so forth, all by way of nonlimiting example. A single such mass may be used, as may multiple such masses 56 distributed for example about the passive radiator 36 in the manner shown for example in FIG. 4C hereof, which depicts the radiator 36 of FIG. 4A along viewplane 54.

In some embodiments, the passive radiator 36 has a mass of about 2 to 30 times that (of the combined mass) of the active diaphragm(s) 34 and, preferably, 10 to 20 times that (of the combined mass) of the active diaphragm(s) 34 and, still more preferably, 10 times that (of the combined mass) of the active diaphragm(s) 34. Thus, for example, if the active diaphragm(s) 34 has/have a combined weight of 1 gram, the annular passive diaphragm 36 has a weight of 10 grams. Likewise, in some embodiments, the passive radiator 36 has a surface area of about 1 to 5 times that (of the combined surface area) of the active diaphragm(s) 34 and, preferably, about 2 times that (of the combined surface area) of the active diaphragm(s) 34. The aforesaid comparative masses and surface areas of the passive radiator 36 and active diaphragm(s) 34 are with respect to the moving components of the radiator 36 and diaphragm(s) 34, respectively, and, thus, may include seals 46, 49 or other components that are affixed to the radiator 36 and diaphragm(s) 34 and that move therewith when sound is radiated thereby.

Circuitry 38 conditions the audio signal received by the device 10, e.g., via remote transmission from a radio receiver, stereo, MP3 player or other audio source. That conditioning includes amplification, band-pass filtering, smoothing and so forth, as is common in the art. The circuitry 38 can be powered via a battery (not shown), though, preferably, it is powered via an on-board transformer or other components of circuitry 38 that converts for use by the loudspeaker 10 line (or other) voltage received from mounting adapter 12 from the E27 or other socket to which it is coupled.

FIG. 3 is a cross-sectional view of an alternate configuration of the loudspeaker of FIG. 2. The loudspeaker of FIG. 3 is constructed and operated similarly to that of FIG. 2, with the following caveats:
In the embodiment of FIG. 3, the printed circuit board 52′ is substituted for board 52 (of FIG. 2) and extends further distally within proximal volumetric region 28 to a vicinity of active diaphragm(s) 34, as shown, e.g., so as to permit those diaphragm(s) to be coupled to driver 32
In the embodiment of FIG. 3, frame 48 is eliminated in favor of placing the driver 32 on printed circuit board 52′.
In the embodiment of FIG. 3, frame 50′ is substituted for frame 50 (of FIG. 2) and extends further distally within cavity 24, e.g., toward grill 16, as shown. An alternate view of the frame 50′ is provided in FIG. 4A, where it appears as tube-like structure with apertures 58, along with support ribbing and flanges. The frame 50′ may be fabricated from the same materials as body 14, e.g., glass, ceramic, wood, metal, epoxies, polymers, other materials (and/or a combination of the foregoing).
In the embodiment of FIG. 3, apertures 58 in frame 50′ facilitate propagation of back waves within the proximal volumetric region 28 from the active diaphragm 34 to the passive diaphragm 36.

Moreover, in addition to sound-making componentry, loudspeaker 10 can include lighting sources 60, e.g., as shown in FIG. 3. This can be a ring-shaped or other arrangement of LEDs, incandescents or otherwise, e.g., of the type commercially available in the marketplace as adapted for affixation to loudspeaker 10 and, preferably, within cavity 26. The source(s) can be powered by circuitry 38 via leads 42 or otherwise.

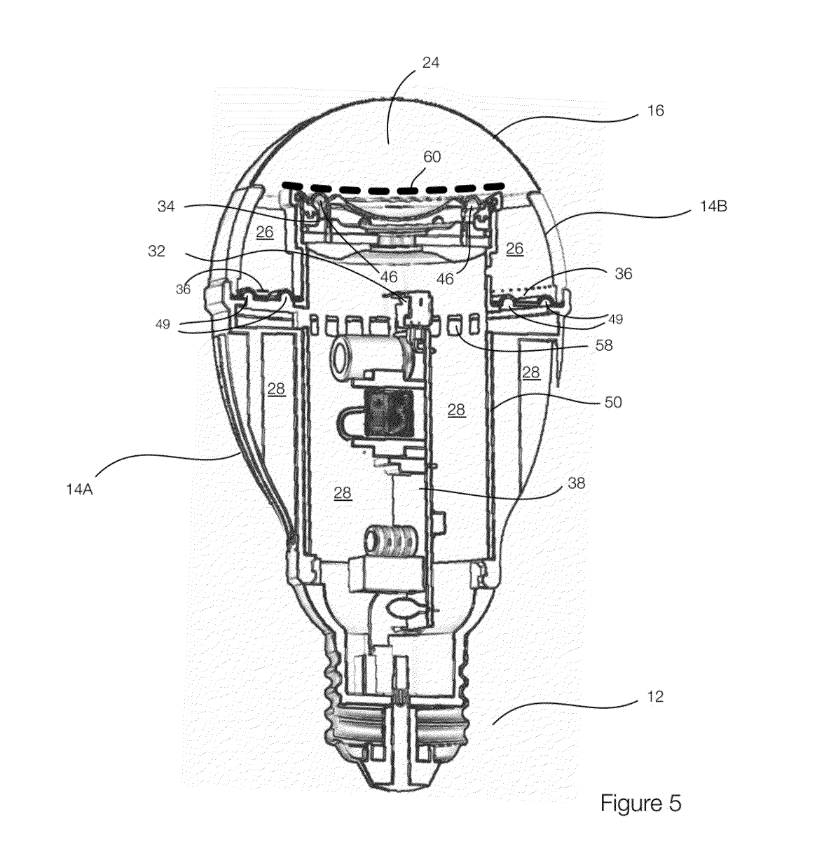

FIG. 5 is a plan view of the loudspeaker shown in FIG. 4A.

Described above are loudspeakers meeting the objects set forth above, among others. It will be appreciated that the embodiments shown in the drawing and described here are merely examples of the invention and that other embodiments incorporating changes therein fall within the scope of the invention. Thus, for example, although the illustrated embodiments include a light source 60 that is disposed within the body 14, in other embodiments such a light source may disposed within or about the body. In view of these and other changes, I claim:

In view of the foregoing, what I claim is:

1. A loudspeaker, comprising,
A. a body having a concavity that includes a first volumetric region,
B. a wall that is disposed within the body and that at least partially defines the first volumetric region,
C. the wall including one or more active diaphragms that are coupled to one or more active drivers, the one or more active diaphragms generating
front waves directed from the first volumetric region to at least one of an environment and a second volumetric region, if any, defined within the concavity, and
back waves directed into the volumetric region,
D. a passive radiator elastically mounted in the wall that passes from the volumetric region at least a portion of back waves generated by one or more of the active diaphragms, and
E. an adapter coupled to the body for mounting in a lightbulb socket.

2. The loudspeaker of claim 1, wherein the one or more active drivers are disposed in the first volumetric region.

3. The loudspeaker of claim 1, wherein the body is shaped like a lightbulb.

4. The loudspeaker of claim 1, wherein the passive radiator is annularly shaped.

5. The loudspeaker of claim 4, wherein the passive radiator is disposed about one or more of the active diaphragms.

6. The loudspeaker of claim 4, wherein the passive radiator includes an elastomer.

7. The loudspeaker of claim 4, wherein the passive radiator is formed of brass.

8. The loudspeaker of claim 1, wherein the one or more active diaphragms include a first active diaphragm and a second diaphragm that is mounted onto coaxially onto a driver of the first active diaphragm.

9. The loudspeaker of claim 8, wherein the first active diaphragm is cone-shaped and wherein the second active diaphragm is mounted substantially coplanar with a forward edge of the first active diaphragm.

10. The loudspeaker of the claim 1, with the one or more active diaphragms and one or more active drivers form part of a two-diaphragm concentric single-magnet speaker.

11. An illuminated loudspeaker, comprising,
A. a body having a concavity that includes a first volumetric region,
B. a wall that is disposed within the body and that at least partially defines the first volumetric region,
C. the wall including one or more active diaphragms that are coupled to one or more active drivers, the one or more active diaphragms generating
front waves directed from the first volumetric region to at least one of an environment and a second volumetric region, if any, defined within the concavity, and
back waves directed into the volumetric region,
D. a passive radiator elastically mounted in the wall that passes from the volumetric region at least a portion of back waves generated by one or more of the active diaphragms,
E. a lighting source disposed any of within or about the body, and
F. an adapter coupled to the body for mounting in a lightbulb socket.

12. The loudspeaker of claim 11, wherein the passive radiator is annularly shaped.

13. The loudspeaker of claim 12, wherein the passive radiator is disposed about one or more of the active diaphragms.

14. The loudspeaker of claim 11, wherein the passive radiator is formed of brass.

15. The loudspeaker of claim 11, wherein the one or more active diaphragms comprise first and second diaphragms coupled back-to-back with one another, the second diaphragm being cone-shaped and facing into the interior of the first volumetric region.

16. The loudspeaker of claim 15, wherein the one or more active drivers comprise a voice coil at least partially disposed within a face of the cone-shaped second diaphragm.

17. The audio headphone of claim 11, wherein the one or more active diaphragms include a first active diaphragm and a second diaphragm that is mounted onto coaxially onto a driver of the first active diaphragm.

18. The audio headphone of claim 17, wherein the first active diaphragm is cone-shaped and wherein the second active diaphragm is mounted substantially coplanar with a forward edge of the first active diaphragm.

19. The audio headphone of the claim 11, with the one or more active diaphragms and one or more active drivers form part of a two-diaphragm concentric single-magnet speaker.
